(19) United States
(12) Patent Application Publication
(10) Pub. No.: US 2014/0232751 A1
(43) Pub. Date: Aug. 21, 2014

(54) INFORMATION DISPLAY DEVICE, METHOD OF DISPLAYING INFORMATION, AND COMPUTER PROGRAM PRODUCT

(71) Applicant: JVC KENWOOD Corporation, Yokohama-shi (JP)

(72) Inventor: Mitsuo Hayashi, Yokohama-shi (JP)

(73) Assignee: JVC KENWOOD Corporation, Yokohama-shi (JP)

(21) Appl. No.: 14/260,036

(22) Filed: Apr. 23, 2014

Related U.S. Application Data
(63) Continuation of application No. PCT/JP2012/075068, filed on Sep. 28, 2012.

(30) Foreign Application Priority Data
Oct. 25, 2011 (JP) 2011-233601

(51) Int. Cl. G09G 5/40; G06T 11/60

(52) U.S. Cl. CPC G09G 5/40; G06T 11/60; G09G 2340/12
USPC 345/636

(57) ABSTRACT

Provided is an information display device that includes: a transmittance setting unit configured to set, to a first character transmittance, a character information transmittance that indicates a degree that character information included in first display information of display information to be displayed in a display unit transmits second display information that is the display information, and to set, to a first image transmittance different from the first character transmittance, an image information transmittance that indicates a degree that image information included in the first display information transmits the second display information; a superimposed information generation unit configured to generate superimposed information in which the second display information and the first display information to which the transmittances have been set by the transmittance setting unit are superimposed; and a display processing unit configured to display the superimposed information in the display unit.

### CROSS-REFERENCE TO RELATED APPLICATIONS

This application is a continuation of PCT international application Ser. No. PCT/JP2012/075068 filed on Sep. 28, 2012 which designates the United States, incorporated herein by reference, and which claims the benefit of priority from Japanese Patent Applications No. 2011-233601, filed on Oct. 25, 2011, incorporated herein by reference.

### BACKGROUND OF THE INVENTION

1. Field of the Invention

The present invention relates to an information display device, a method of displaying information, and a computer program product.

2. Description of the Related Art

Conventionally, in a personal computer (PC), windows of a plurality of running applications can be displayed on a display screen at the same time. In contrast, in a mobile information device such as a mobile terminal, although a plurality of applications can be operated at the same time, a plurality of pieces of display information generated by the plurality of applications cannot be displayed at the same time.

In the PC, an internet screen and a television program screen can be displayed at the same time using a multi-window display that displays a plurality of windows at the same time. Therefore, the user can easily view an internet browser and can watch the television by moving a view. That is, the user can watch a television program while viewing something on the display screen of the PC. In contrast, in the mobile information device, the multi-window display cannot be performed. Thus, if the user wishes to watch a television program while browsing the internet screen, the user needs to terminate the internet browser application once, and to start a television application. Therefore, in the mobile information device, the user cannot watch a television program while viewing something.

Causes to hinder the multi-window screen of the mobile information device include a low resolution of the screen of the mobile information device, low processing performance of a CPU, and large power consumption of the multi-window display. However, as can be seen in the wide spread of smart phones in recent years, a multiprocessor of the CPU used in the mobile information device has been improved, and the processing performance tends to be improved. As mobile phones are said to have become personal computers, the causes are being solved.

However, in the mobile information device, portability needs to be secured. Thus, the size of the display device needs to be limited to about three to four inches. Therefore, when the multi-window display is employed in the mobile information device, there are problems that each window size becomes small and the visibility is poor. In addition, in the mobile information device, there are problems that an input method of an input device is limited and operation accuracy is low; and thus, operations such as selecting and moving the window, and changing the size are difficult to perform, and the operability is poor.

By the way, Japanese Patent Application Laid-open (JP-A) No. 2002-140265 discloses a technology to superimpose a mail body on an attached image as a background and to display them in a display unit, in a mobile terminal. This enables the user to confirm the attached image and the mail body at a glance even with a display device having a limited size. Further, Japanese Patent Application Laid-open (JP-A) No. 2007-266800 discloses a technology to superimpose and display a plurality of programs in an information reproduction device.

However, there is a problem that, when the plurality of pieces of display information is superimposed and displayed, each piece of display information cannot be easily viewed.

### SUMMARY OF THE INVENTION

There is a need to at least partially solve the problems in the conventional technology.

Provided is an information display device that includes: a transmittance setting unit configured to set, to a first character transmittance, a character information transmittance that indicates a degree that character information included in first display information of display information to be displayed in a display unit transmits second display information that is the display information, and to set, to a first image transmittance different from the first character transmittance, an image information transmittance that indicates a degree that image information included in the first display information transmits the second display information; a superimposed information generation unit configured to generate superimposed information in which the second display information and the first display information to which the transmittances have been set by the transmittance setting unit are superimposed; and a display processing unit configured to display the superimposed information in the display unit.

Provided further is a method of displaying information executed in an information display device. The method includes: transmittance setting that includes setting, to a first character transmittance, a character information transmittance that indicates a degree that character information included in first display information of display information to be displayed in a display unit transmits second display information that is the display information, and setting, to a first image transmittance different from the first character transmittance, an image information transmittance that indicates a degree that image information included in the first display information transmits the second display information; superimposed information generating that includes generating superimposed information in which the second display information and the first display information to which the transmittances have been set in the transmittance setting are superimposed; and display processing that includes displaying the superimposed information in the display unit.

Provided still further is a computer program product that includes a computer-usable medium having computer-readable program codes embodied in the medium for causing a computer to execute: transmittance setting that includes setting, to a first character transmittance, a character information transmittance that indicates a degree that character information included in first display information of display information to be displayed in a display unit transmits second display information that is the display information, and setting, to a first image transmittance different from the first character transmittance, an image information transmittance that indicates a degree that image information included in the first display information transmits the second display information; superimposed information generating that includes generating superimposed information in which the second display information and the first display information to which the transmittances have been set in the transmittance setting are superimposed; and display processing that includes displaying the superimposed information in the display unit.

The above and other objects, features, advantages and technical and industrial significance of this invention will be better understood by reading the following detailed description of presently preferred embodiments of the invention, when considered in connection with the accompanying drawings.

### BRIEF DESCRIPTION OF THE DRAWINGS

FIG. 1 is a perspective view of an appearance configuration of an information display device;

FIG. 2 is a block diagram illustrating a function configuration of a display control unit;

FIG. 3A is a diagram illustrating display information;

FIG. 3B is a diagram illustrating character information;

FIG. 3C is a diagram illustrating image information;

FIG. 4A is a diagram illustrating display information;

FIG. 4B is a diagram illustrating character information;

FIG. 4C is a diagram illustrating image information;

FIG. 5 is a diagram illustrating a data configuration of an attribute table;

FIG. 6 is a diagram illustrating a data configuration of a function identification table;

FIG. 7 is a diagram illustrating a slider;

FIG. 8 is a diagram illustrating graphs of a first character function, a first image function, a second character function, and a second image function;

FIG. 9A is a diagram illustrating a slider position and superimposed information;

FIG. 9B is a diagram illustrating a slider position and superimposed information;

FIG. 9C is a diagram illustrating a slider position and superimposed information;

FIG. 10A is a diagram illustrating a slider position and superimposed information;

FIG. 10B is a diagram illustrating a slider position and superimposed information;

FIG. 10C is a diagram illustrating a slider position and superimposed information;

FIG. 11 is a flowchart illustrating processing by a display control unit;

FIG. 12 is a flowchart illustrating detailed processing in attribute determination processing (step S103);

FIG. 13 is a diagram illustrating a hardware configuration of an information display device;

FIG. 14A is a diagram illustrating an example of first display information;

FIG. 14B is a diagram illustrating an example of second display information;

FIG. 15 is a diagram illustrating a slider position and superimposed information;

FIG. 16 is a flowchart illustrating detailed processing in attribute determination processing (step S103) according to a modification; and

FIG. 17 is a diagram illustrating a data configuration of a transmission coefficient table according to a modification.

### DETAILED DESCRIPTION OF THE PREFERRED EMBODIMENTS

Hereinafter, an information display device, a method of displaying information, and a computer program product according to the present embodiment will be described in detail with reference to the drawings. Note that the present invention is not limited by the embodiments.

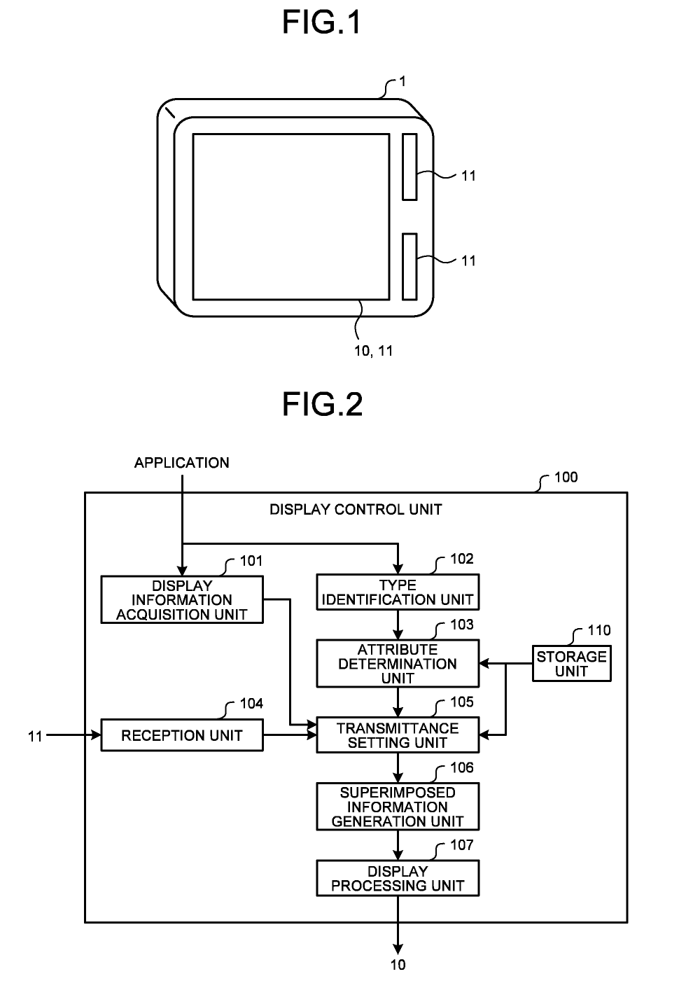

FIG. 1 is a perspective view illustrating an appearance configuration of an information display device 1 according to an embodiment. The information display device 1 includes a display unit 10 and an input unit 11, such as a hard key. The display unit 10 also functions as a touch panel. That is, the display unit 10 also functions as the input unit 11. The information display device 1 is a mobile-type information device, for example, and the touch panel may be a color liquid crystal panel of about three to four inches.

In the information display device 1, applications that generate various types of display information and perform various types of processing are operable. The information display device 1 includes a display control unit that performs display control of various types of display information generated by the applications to the display unit 10.

FIG. 2 is a block diagram illustrating a function configuration of a display control unit 100 of the information display device 1. The display control unit 100 includes a display information acquisition unit 101, a type identification unit 102, an attribute determination unit 103, a reception unit 104, a transmittance setting unit 105, a superimposed information generation unit 106, a display processing unit 107, and a storage unit 110.

When displaying display information in the display unit 10, the display control unit 100 secures a display plane that is a display region in the storage unit 110, and allocates the display information to the display plane. To be specific, when displaying two pieces of display information, the display control unit 100 secures two display planes (a first display plane and a second display plane) in the storage unit 110, allocates one of the two pieces of display information to the first display plane and another piece of display information to the second display plane, and performs processing of superimposing and displaying these pieces of information in the display unit 10.

Here, as the applications, there are various types of applications regarding web browsing, an electronic mail, audio reproduction, an electronic dictionary, an electronic book, map display, navigation, image display, moving image display, television program reproduction, and the like. When generating display information, the application registers the type of application to a property or the like of the generated display information as an attribute. Note that a method of holding the type of application in the display information is not limited to the example.

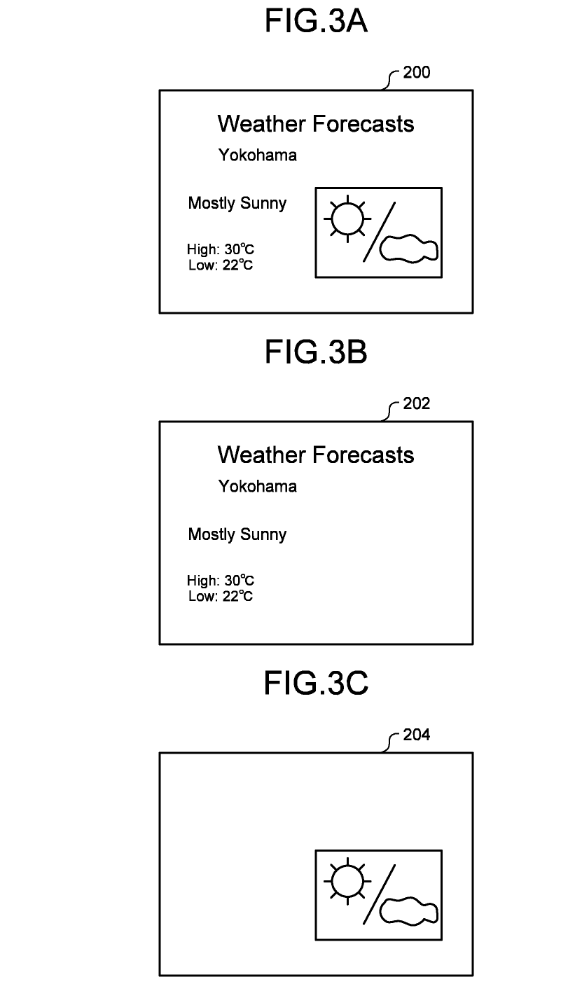

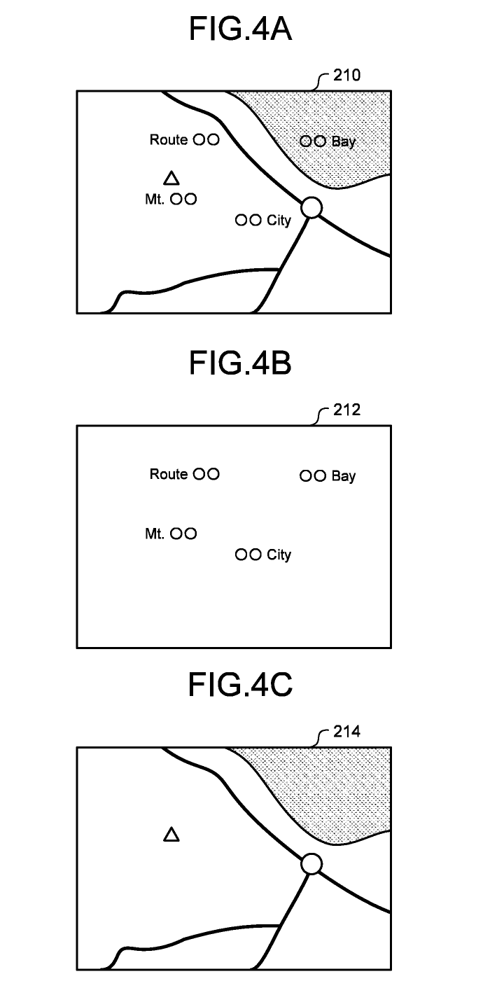

The display information acquisition unit 101 acquires the display information generated by the application from the application. FIGS. 3A to 3C and FIGS. 4A to 4C are diagrams for describing the display information. Display information 200 illustrated in FIG. 3A is information of the display information generated by a web browser application. The display information 200 illustrated in FIG. 3A is configured from character information 202 illustrated in FIG. 3B and image information 204 illustrated in FIG. 3C.

Further, a display information 210 illustrated in FIG. 4A is an example of the display information generated by a map display application. The display information 210 illustrated in FIG. 4A is configured from character information 212 illustrated in FIG. 4B and image information 214 illustrated in FIG. 4C. The display control unit 100 according to the present embodiment processes the display information including the character information and the image information.

Referring back to FIG. 2, the type identification unit 102 identifies the type of application of the generator of the display information. Here, the type of application is the above-described web browsing, the electronic mail, the audio reproduction, or the like. To be specific, the type identification unit 102 identifies the type of application that has generated the display information by identifying the type of the running application, by referring to the attribute of the property of the display information, and the like. Note that the identification of the type of application is not limited to the above example, and for example, the type identification unit 102 may be configured to identify the type of application by an extension of a file name of the display information.

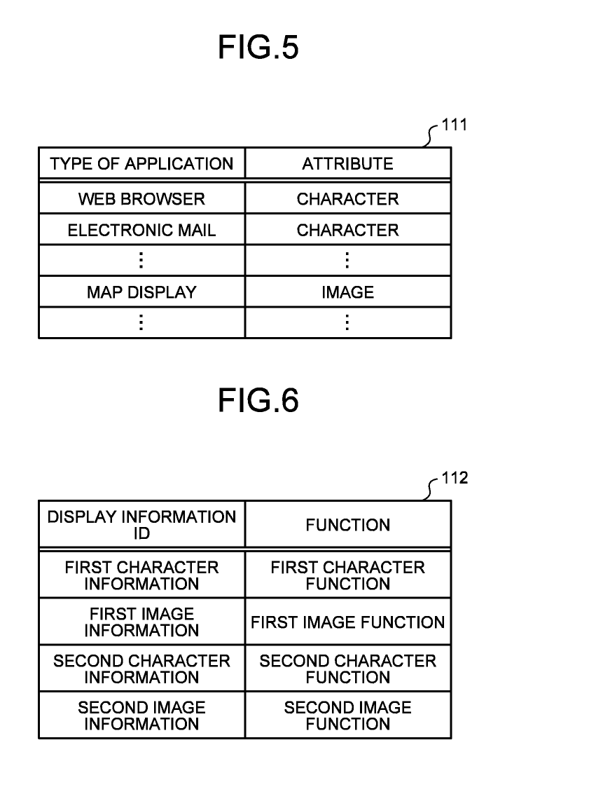

The storage unit 110 stores an attribute table 111 and a function identification table 112. The attribute table 111 is data that determines whether main information of the display information generated by the type of application is a character or an image, that is, data that determines an attribute for each type of the application. FIG. 5 illustrates a data configuration of the attribute table 111. As illustrated in FIG. 5, the attribute table 111 stores the type of application, and the attribute of the display information generated by the application in association with each other. Here, the attribute of the display information means either a character or an image, and the attribute registered here is the main information of the display information. In the example of FIG. 5, the display information generated by the application of the type of application “web browser” is determined as information having a character (character information) as the main information; and the display information generated by the application of the type of application “map display” is determined as information having an image (image information) as the main information. Note that in the attribute table 111, the attribute that is the main information of the display information is arbitrarily determined by the user in advance with respect to the type of application based on judgment of the user, and the attribute that is the main information of the display information generated by the application is not limited to the attribute determined in the attribute table 111. Further, the attribute table 111 of FIG. 5 is also an example, and the table is not limited to this example.

FIG. 6 is a diagram illustrating a data configuration of the function identification table 112. The function identification table 112 is data in which a function for calculating a transmittance in the display information is determined for each piece of display information. As illustrated in FIG. 6, the function identification table 112 stores display information IDs that identify respective pieces of display information such as first character information, first image information, second character information, and second image information, and functions for calculating transmittances of respective pieces of display information (a first character function, a first image function, a second character function, and a second image function) in association with each other.

Here, the first character information and the first image information are character information and image information included in the first display information displayed in the first display plane, respectively. Further, the second character information and the second image information are character information and image information included in the second display information displayed in the second display plane, respectively.

The first character function, the first image function, the second character function, and the second image function are functions of a transmittance and a display ratio. Here, the display ratio is a display ratio of the second display information displayed in the display unit 10. Note that, in any case where the display ratio of the second display information takes any value, a total of the display ratio of the first display information and the display ratio of the second display information becomes 100%.

The transmittance is a value indicating the degree of transmitting other information superimposed and displayed on each piece of information. The transmittance 100% corresponds to complete transparency, and the transmittance 0% corresponds to non-transparency. Note that, in the present embodiment, as an index corresponding to the transmittance of each piece of information, a transmission coefficient is used. That is, the first character function, the first image function, the second character function, and the second image function according to the present embodiment are functions of a display ratio and a transmission coefficient. The transmission coefficient is a value to be multiplied to each piece of information, and the transmittance of each piece of information is changed by being multiplied by the transmission coefficient.

The transmission coefficient takes values from 0% to 100%. The transmission coefficient 0% corresponds to complete transparency, and information multiplied by the transmission coefficient 0% is not displayed in the display unit 10, and only another piece of information superimposed and displayed on the information is displayed. The transmission coefficient 100% corresponds to non-transparency, and information multiplied by the transmission coefficient 100% is displayed as it was generated by the application, and another piece of information superimposed and displayed on the information is not displayed. That is, the transmission coefficient 0% corresponds to the transmittance 100% that indicates the degree of transmission, and the transmission coefficient 100% corresponds to the transmittance 0%.

Referring back to FIG. 2, the attribute determination unit 103 identifies, in the attribute table 111, an attribute associated with the type of application identified by the type identification unit 102. When the display information acquisition unit 101 acquires two pieces of display information, and the acquired two pieces of display information are display information of a character attribute and display information of an image attribute, the attribute determination unit 103 determines the display information of the character attribute as the first display information to be displayed in the first display plane, and the display information of the image attribute as the second display information to be displayed in the second display plane.

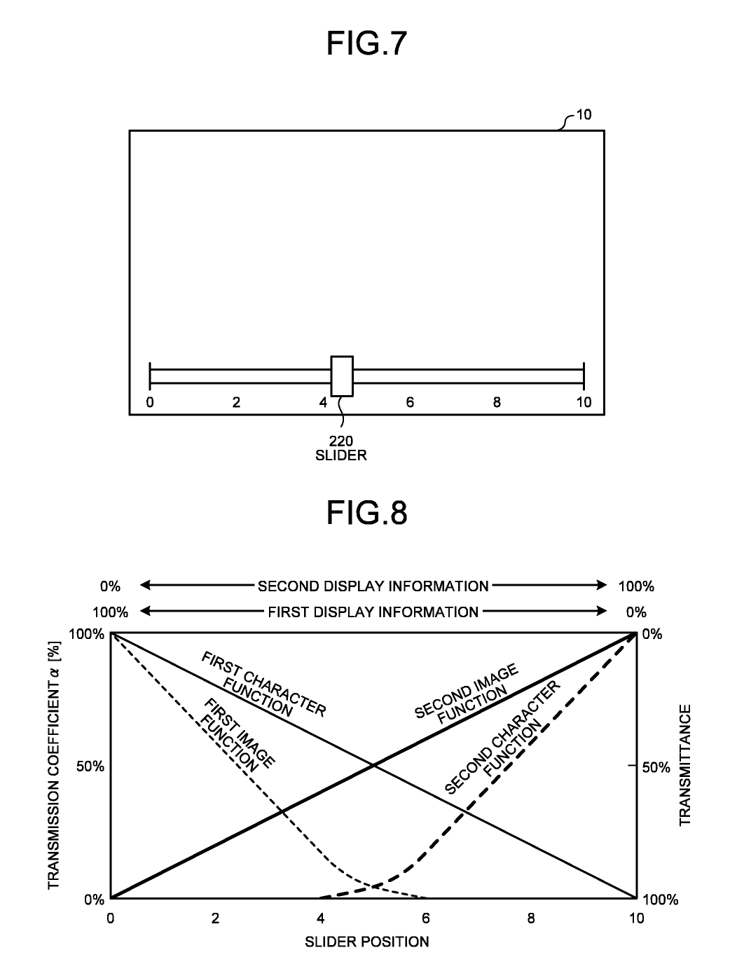

The reception unit 104 receives designation of the display ratio input from the user. To be specific, as illustrated in FIG. 7, when a slider 220 displayed in the display unit 10 is touched with a finger, and the position of the slider 220 is changed, the display ratio is designated. In the present embodiment, a slider position 0 corresponds to the display ratio 100% of the first display information and the display ratio 0% of the second display information. A slider position at 2 in FIG. 7 corresponds to the display ratio 80% of the first display information and the display ratio 20% of the second display information. A slider position at 10 in FIG. 7 corresponds to the display ratio 0% of the first display information and the display ratio 100% of the second display information.

The slider position can be changed by an operation of pressing a hard key by the user, in addition to the operation of touching the touch panel with a finger by the user. Note that the operation method by the user for designating the display ratio is not limited to the embodiment.

Here, the first character function, the first image function, the second character function, and the second image function will be described. FIG. 8 illustrates graphs illustrating the first character function, the first image function, the second character function, and the second image function. The horizontal axis of the graph illustrated in FIG. 8 represents the display ratios of the first display information and the second display information and the slider position, and the vertical axis represents the transmission coefficient and the transmittance. The four functions are mutually different functions.

The first character function and the first image function are functions in which the transmission coefficient is decreased as the display ratio of the second display information is increased (the value of the slider position is increased). That is, according to these functions, the transmittances of the first character information and the first image information are increased as the display ratio of the second display information is increased.

Accordingly, the first character information and the first image information are gradually palely displayed as the display ratio of the second display information is increased. That is, the first character information and the first image information gradually fade out from the display unit 10. Then, in the display ratio 100% (slider position at 10) of the second display information, the first character information and the first image information become completely transparent, and any information is not displayed.

Meanwhile, the second character function and the second image function are functions in which the transmission coefficients are increased as the display ratio of the second display information is increased (the value of the slider position is increased). That is, according to the functions, the transmittances of the second character information and the second image information are decreased as the display ratio of the second display information is increased. Accordingly, the display of the second character information and the second image information in the display unit 10 becomes gradually clear as the display ratio of the second display information is increased. That is, the second character information and the second image information gradually fade in to the display unit 10.

As described above, when the first display information and the second display information multiplied by the transmission coefficients are superimposed, a state, in which only the first display information is displayed as the display ratio of the second display information is increased, is changed into a state in which the second display information gradually fades in and the first display information and the second display information are displayed together, and to a state in which the first display information is started to fade out and only the second display information is displayed. That is, cross-fading display is realized, in which the second display information fades in as the first display information fades out.

Further, the first character function is a function in which the transmission coefficient calculated by the first character function has a larger value than the transmission coefficient calculated by the first image function in any display ratio except the case in which the display ratio of the first display information is 100% (the first display information is not transparent).

To be specific, the first character function is a function that is inversely proportional to the display ratio of the second display information, and in which the transmission coefficient is changed from 100% to 0% when the display ratio of the second display information takes a value from 0% to 100%.

In contrast, the first image function is a function in which the transmission coefficient is decreased with a steeper inclination than the first character function with an increase of the display ratio of the second display information. To be specific, the first image function is a function is a function in which the transmission coefficient becomes 0% when the display ratio of the second display information is increased up to about 50%; and in the first image function according to the present embodiment, the transmission coefficient becomes 0% when the display ratio of the second display information becomes 60%. Further, the first image function is a function in which an average change rate is decreased as the display ratio of the second display information is increased, that is, a function of a downwardly convex curve graph.

That is, when the first character information is multiplied by the transmission coefficient calculated by the first character function, and the first image information is multiplied by the transmission coefficient calculated by the first image function, the first character information and the first image information are started to fade out from the display unit 10 as the display ratio of the second display information is increased from 0%. When the display ratio is increased to 60%, the first image information becomes completely transparent, and is not displayed in the display unit 10. Following that, the display ratio reaches 100%, the first character information becomes also completely transparent, and is not displayed in the display unit 10.

As described above, when causing the display information determined as the first display information and including a character as the main information to gradually fade out as the display ratio of the second display information is increased from 0% to 100%, the display control unit 100 can cause the first image information of the first display information to fade out earlier than the first character information, using the first character function and the first image function. Further, when the display ratio exceeds 60%, the display control unit 100 displays only the first character information that is the main information regarding the first display information, whereby the second image information that is started to fade in and the first image information do not coexist, and the visibility of the second image information of the second display information can be improved.

Meanwhile, the second image function is a function in which the transmission coefficient calculated by the second image function has a larger value than the transmission coefficient calculated by the second character function in any display ratio except the case in which the display ratio of the second display information is 100% (the second display information is not transparent).

To be specific, the second image function is a function in which the display ratio of the second display information and the transmission coefficient are proportional to each other, and is a function in which the transmission coefficient is decreased from 100% to 0% as the display ratio of the second display information is decreased from 100% to 0%.

In contrast, the second character function is a function in which the transmission coefficient is more steeply decreased than the second image function as the display ratio of the second display information is decreased from 100% to 0%. To be specific, the second character function is a function in which, when the display ratio of the second display information is decreased to about 50%, the transmission coefficient becomes 0%. In the second character function according to the present embodiment, when the display ratio of the second display information is decreased to 40%, the transmission coefficient becomes 0%. Further, the second character function is a function in which the average change rate is decreased as the display ratio of the second display information is decreased, that is, a function of a downwardly convex curve graph.

That is, when the second character information is multiplied by the transmission coefficient calculated by the second character function, and the second image information is multiplied by the transmission coefficient calculated by the second image function, the second character information and the second image information are started to fade out from the display unit 10 as the display ratio of the second display information is decreased from 100%. When the display ratio is decreased to 40%, the second character information becomes completely transparent, and is not displayed in the display unit 10. Then, when the display ratio reaches 0%, the second image information also becomes completely transparent, and is not displayed in the display unit 10.

As described above, when causing the display information determined as the second display information and including an image as the main information to gradually fade out as the display ratio of the second display information is decreased from 100% to 0%, the display control unit 100 can cause the second character information of the second display information to fade out earlier than the second image information, by using the second character function and the second image function. Further, when the display ratio becomes smaller than 40%, the display control unit 100 displays only the second image information that is the main information regarding the second display information, whereby the first character information that is started to fade in and the second character information do not coexist, and the visibility of the first character information of the first display information can be improved.

Note that the first character function and the first image function may just be functions in which the transmission coefficients are decreased as the display ratios of the second display information are increased, and the relation between the display ratio and the transmittance in each function is not limited to the embodiment.

For example, the first character function according to the present embodiment is a function in which the display ratio of the second display information and the transmission coefficient are inversely proportional to each other, that is, a function of a straight line graph. However, the first character function may be a function of a downwardly convex curve graph instead.

Further, the first image function according to the present embodiment is a downwardly convex curve graph. However, the first image function may be a straight line graph instead.

Further, the first character function according to the present embodiment is a function in which the transmission coefficient is changed from 100% to 0% when the display ratio of the second display information takes a value from 0% to 100%. However, alternatively, the first character function may be a function in which the transmission coefficient is changed from 100% to 0% when the display ratio of the second display information takes a value from 0% to a smaller value than 100% (for example, 90%).

Similarly, the second character function and the second image function may just be functions in which the transmission coefficients are decreased as the display ratios of the second display information are decreased. The relation between the display ratio and the transmittance in each function is not limited to the embodiment.

For example, the second image function according to the present embodiment is a function in which the display ratio of the second display information and the transmission coefficient are proportional to each other, that is, a function of a straight line graph. However, the second image function may be a function of a downwardly convex curve graph instead.

Further, the second character function according to the present embodiment is a downwardly convex curve graph. However, the second character function may be a straight line graph instead.

Further, the second image function according to the present embodiment is a function in which the transmission coefficient is changed from 0% to 100% when the display ratio of the second display information takes a value from 0% to 100%. However, alternatively, the second image function may be a function in which the transmission coefficient is changed from 0% to 100% when the display ratio of the second display information takes a value from a larger value than 0% (for example, 10%) to 100%.

Further, the first character function, the first image function, the second character function, and the second image function according to the present embodiment are functions using the display ratios of the second display information and the transmission coefficients as variables. However, the variables of the functions may be the display ratios of the first display information or the slider positions, in place of the display ratios of the second display information.

Further, the first character function, the first image function, the second character function, and the second image function according to the present embodiment are functions in which the transmittances of the second character information and the second image information become 0% when the transmittances of the first character information and the first image information are 100%, and the transmittances of the second character information and the second image information become 100% when the transmittances of the first character information and the first image information are 0%. However, as another example, the first character function, the first image function, the second character function, and the second image function may be functions in which the transmittances of the second character information and the second image information become a larger value than 0% when the transmittances of the first character information and the first image information are 100%. As still another example, those functions may be functions in which the transmittances of the first character information and the first image information become a larger value than 0% when the transmittances of the second character information and the second image information are 100%.

Referring back to FIG. 2, the transmittance setting unit 105 calculates the transmission coefficients to be respectively multiplied to the first character information and the first image information included in the display information determined by the attribute determination unit 103 as the first display information to be displayed in the first display plane, and to the second character information and the second image information included in the display information determined as the second display information to be displayed in the second display plane, based on the first character function, the first image function, the second character function, and the second image function associated with the respective pieces of information in the function identification table 112 stored in the storage unit 110, and the display ratio received by the reception unit 104 or the display ratio set as a default value in advance. Then, the transmittance setting unit 105 sets the transmittances of respective pieces of information by multiplying the first character information, the first image information, the second character information, and the second image information by the calculated transmission coefficients, respectively. As described above, the transmittance setting unit 105 sets the transmittance of each piece of information to the transmittance determined according to a predetermined display ratio.

The superimposed information generation unit 106 superimposes the first display information in which the transmittances have been changed by the transmittance setting unit 105 to the second display information in which the transmittances have been changed to generate the superimposed information. The display processing unit 107 displays the superimposed information generated by the superimposed information generation unit 106 in the display unit 10.

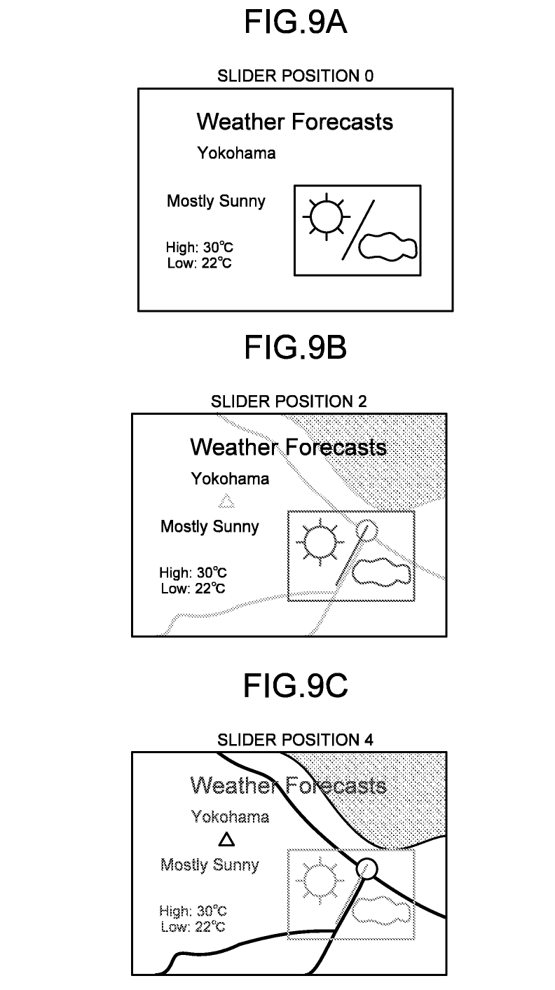

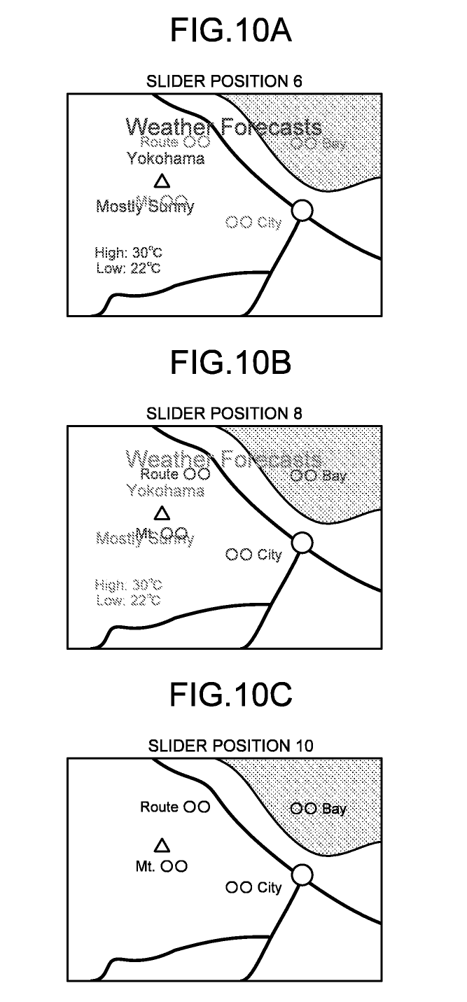

FIGS. 9A to 9C and 10A to 10C are diagrams illustrating slider positions and superimposed information displayed in the display unit 10 by the display control unit 100 when the slider positions are designated. FIGS. 9A to 9C and 10A to 10C illustrate the superimposed information of when the display information illustrated in FIGS. 3A to 3C is the first display information, and the display information illustrated in FIGS. 4A to 4C is the second display information. In a slider position 0, as illustrated in FIG. 9A, the first character information and the first image information included in the first display information are displayed in the display unit 10 without being changed from the state generated by the application.

Further, in slider positions 2 and 4, as illustrated in FIGS. 9B and 9C, the second image information of the second display information is displayed in the display unit 10 in addition to the first character information and the first image information included in the first display information.

Further, while, in the slider position 2, the first image information is displayed more clearly than the second image information; in the slider position 4, the second image information is displayed more clearly than the first image information.

As described above, when the slider positions 2 and 4 are designated, the display control unit 100 displays only the second image information that is the main information regarding the second display information while relatively clearly displaying the first character information and the first image information regarding the first display information. Therefore, the user can visually recognize the first display information clearly, and can get to know the outline of the second display information. Further, when the second image information is a map image, in the slider positions 2 and 4, the map is displayed to the extent that the user can recognize the geographical feature. Therefore, the user can get to know a rough place.

Further, in slider positions 6 and 8, as illustrated in FIGS. 10A and 10B, not only the second image information but also the second character information is displayed in the display unit 10 regarding the second display information. Further, as for the first display information, the first image information included in the first display information completely fades out, and only the first character information is displayed in the display unit 10.

Further, while, in the slider position 6, the first character information is more clearly displayed than the second character information; in the slider position 8, the second character information is more clearly displayed than the first character information.

As described above, when the slider positions 6 and 8 are designated, the display control unit 100 displays only the first character information that is the main information regarding the first display information, while relatively clearly displaying the second character information and the second image information included in the second display information. Therefore, the user can visually recognize the second display information clearly, and can get to know the outline of the first display information.

Further, in a slider position 10, as illustrated in FIG. 10C, the second character information and the second image information included in the second display information are displayed in the display unit 10 without being changed from the state generated by the application.

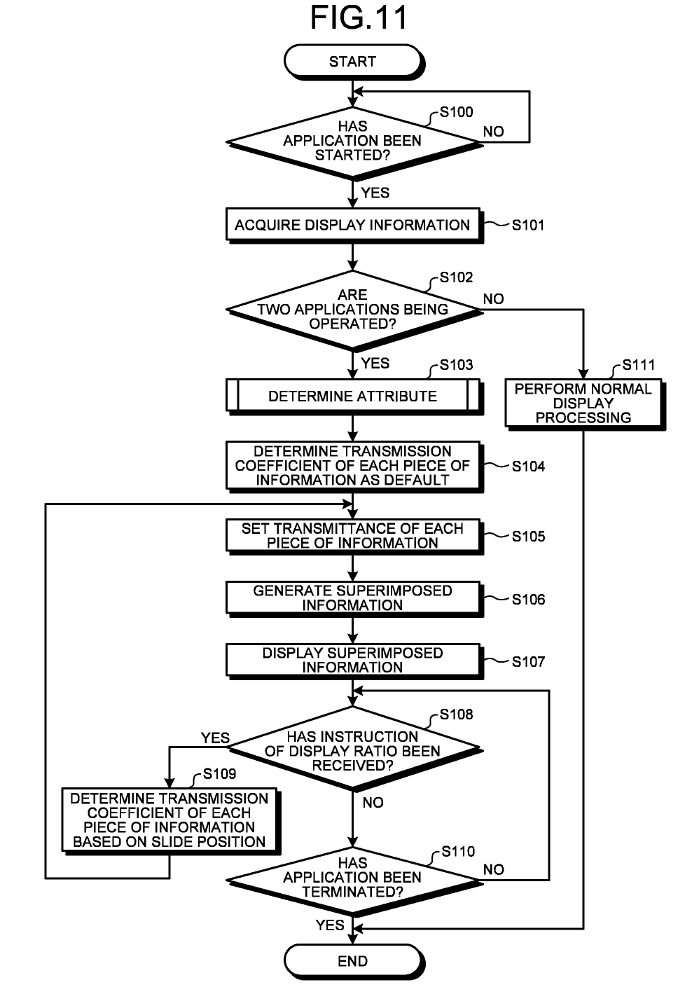

Next, display processing by the display control unit 100 of the information display device 1 configured as described above, according to the present embodiment will be described. FIG. 11 is a flowchart illustrating processing by the display control unit 100. First, the display control unit 100 is in a start waiting state of an application that displays display information in the information display device 1 (No in step S100). When an application that displays display information is started (Yes in step S100), the display information acquisition unit 101 acquires the display information from the started application (step S101). Next, the display information acquisition unit 101 determines whether two applications are being operated by determining whether the display information acquisition unit 101 has acquired two pieces of display information (step S102). When the display information acquisition unit 101 has acquired two pieces of display information, that is, when two applications are being operated in the information display device 1 (Yes in step S102), the processing proceeds to the attribute determination processing (step S103).

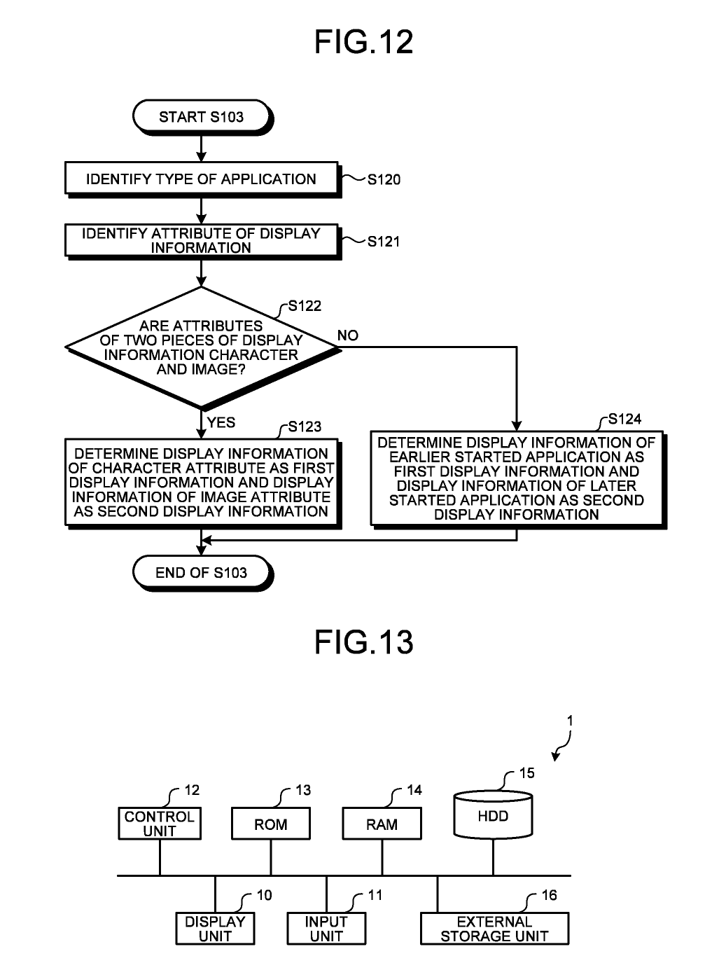

FIG. 12 is a flowchart illustrating detailed processing of the attribute determination processing (step S103). In the attribute determination processing, first, the type identification unit 102 identifies the types of the two applications that are generators of the two pieces of display information (step S120). Next, the attribute determination unit 103 identifies, in the attribute table 111 of the storage unit 110, the attributes of the display information associated with the two types of application identified by the type identification unit 102 (step S121), and determines whether the attribute of one piece of the display information of the two pieces of display information generated by the two application is a character, and the attribute of the other piece of the display information of the two pieces of display information is an image (step S122).

Then, when the attribute of one piece of the display information of the two pieces of display information is a character, and the attribute of the other piece of the display information of the two pieces of display information is an image (Yes in step S122), the attribute determination unit 103 determines the display information having the character attribute as the first display information to be displayed in the first display plane, and the display information having the image attribute as the second display information to be displayed in the second display plane (step S123).

In step S122, when it is a case other than the case in which the attributes of the two pieces of display information are a character and an image (No in step S122), the attribute determination unit 103 determines the display information generated by an application started earlier as the first display information, and the display information generated by an application started later as the second display information (step S124). The attribute determination processing (step S103) ends.

Note that, in step S122, when it is a case other than the case in which the attributes of the two pieces of display information are a character and an image, a case in which the attribute of at least one of the two pieces of display information is not registered in the attribute table 111, and the attribute cannot be identified is included, in addition to a case in which the attributes of the two pieces of display information are both characters, and a case in which the attributes of the two pieces of display information are both images.

Again, referring back to FIG. 11, when the attribute determination processing (step S103) ends, next, the transmittance setting unit 105 determines the transmission coefficients of the first character information and the first image information of the first display information and the second character information and the second image information of the second display information based on the functions stored in the function identification table 112 of the storage unit 110 and the display ratio set in advance as default (step S104). Here, the display ratio set as default is 50% in the present embodiment. However, the display ratio set as default is not limited to the embodiment, and another value can be set as default. Further, the default value can be changed according to a change instruction from the user.

Next, the transmittance setting unit 105 changes the transmittance of each piece of information by multiplying the information by the transmission coefficient determined for each piece of information (step S105). Next, the superimposed information generation unit 106 generates superimposed information by superimposing the first display information of which transmittance has been changed by the transmittance setting unit 105 onto the second display information of which transmittance has been changed by the transmittance setting unit 105 (step S106). Next, the display processing unit 107 displays the superimposed information generated by the superimposed information generation unit 106 in the display unit 10 (step S107).

Accordingly, when two applications are started, and two pieces of display information generated by the two applications are displayed in the display unit 10, the display control unit 100 displays the superimposed information that is obtained by superimposing the two pieces of display information at the default ratio set in advance. Therefore, the user can browse the two pieces of display information in a favorable state.

Further, at this time, the display processing unit 107 displays the slider 220 in the display unit 10 together with the superimposed information. Then, the slider position is changed by the user, and the reception unit 104 determines whether having received designation of the display ratio (step S108). When the reception unit 104 has received designation of the display ratio (Yes in step S108), the transmittance setting unit 105 determines the transmission coefficient of each piece of information based on the display ratio received by the reception unit 104 and the functions stored in the function identification table 112 (step S109). Then, the processing proceeds to step S105, and the transmittance setting unit 105 changes the transmittance of each piece of information (step S105). Accordingly, in step S107, the superimposed information of the display ratio corresponding to the slider position changed by the user is displayed in the display unit 10.

Meanwhile, in step S108, when the reception unit 104 does not receive designation of the display ratio (No in step S108), whether at least one of the two running applications has been terminated is determined (step S110). When at least one of the two running applications is terminated (Yes in step S110), the display processing is completed. Meanwhile, when the two applications are running (No in step S110), the processing is returned to step S108 again.

Further, in step S102, when the running application is only one (No in step S102), the display processing unit 107 performs normal display processing (step S111), and the display processing is completed.

As described above, according to the information display device 1 of the present embodiment, when two applications are started, two pieces of display information generated by the respective two applications are superimposed and displayed. Therefore, the two pieces of display information can be displayed with a relatively larger size than a case in which two windows that display the two pieces of display information are provided and the two windows that display the two pieces of display information are arranged and displayed in the display unit 10 having a limited size. Therefore, the visibility of the display information can be improved.

Further, the transmittances of the two pieces of display information are changed to adjust which of the two pieces of display information can be more easily viewed according to the change of the slider position by the operation of the user, and cross-fading can be performed. Therefore, the display information desired by the user can be displayed in a more favorable state.

Further, when the two pieces of display information are the display information including a character as the main information and the display information including an image as the main information, display of the image information is limited for the display information including a character as the main information, and display of the character information is limited for the display information including an image as the main information, whereby the visibility of the preferential information can be improved.

FIG. 13 is a diagram illustrating a hardware configuration of the information display device 1. The information display device 1 includes a control unit 12 such as a CPU, a storage unit such as a read only memory (ROM) 13 or a RAM 14, an HDD 15, an external storage unit 16 such as a CD drive device, the display unit 10 such as a display device, and an input unit 11 such as an input key touch panel, and has a hardware configuration using a normal computer.

A program executed in the information display device 1 of the present embodiment is recorded in a computer-readable recording medium such as a CD-ROM, a flexible disk (FD), a CD-R, a digital versatile disk (DVD), or the like with a file in an installable format or an executable format, and is provided.

Further, the program executed in the information display device 1 of the present embodiment may be stored in a computer connected to a network such as the Internet, and may be provided by being downloaded through the network. Further, the program executed by the information display device 1 of the present embodiment may be provided or distributed through a network such as the Internet. Further, the program executed in the information display device 1 of the present embodiment may be incorporated in a ROM or the like in advance and is provided.

The program executed in the information display device 1 according to the present embodiment has a module configuration including the above-described units (the display information acquisition unit, the type identification unit, the attribute determination unit, the reception unit, the transmittance setting unit, the superimposed information generation unit, and the display processing unit), and as actual hardware, the CPU (processor) reads the program from the storage medium and executes the program, so that the above-described units are loaded on the main storage unit and are generated on the main storage unit.

As a first modification of the information display device 1 according to the present embodiment, the information display device 1 may perform similar processing to the processing described in the embodiment not only in the case where each of the two pieces of display information includes the character information and the image information, but also a case in which one of the two pieces of display information includes the character information and the image information, and the other of the two pieces of display information includes only one of the character information and the image information.

In this case, the transmittance setting unit 105 may multiply the character information and the image information included in the one of the two pieces of display information by different transmission coefficients, and multiply the character information or the image information included in the other of the two pieces of display information by a corresponding transmission coefficient, using the functions stored in the function identification table 112, and the superimposed information generation unit 106 may superimpose the two pieces of display information in which the transmittances have been changed to generate the superimposed information.

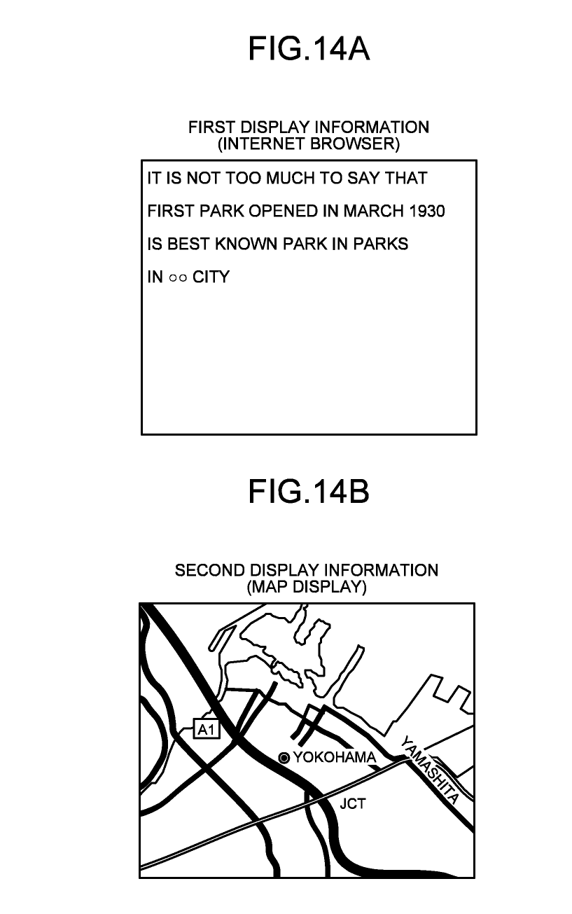

Here, a case in which the information display device 1 employs display information illustrated in FIG. 14A and display information illustrated in FIG. 14B as objects to be displayed will be described. Assume that the display information illustrated in FIG. 14A is the first display information displayed in the first display plane, and the display information illustrated in FIG. 14B is the second display information displayed in the second display plane. Further, the display information illustrated in FIG. 14A is display information generated by an internet browser application, and includes only the character information, and the attribute is the character. Meanwhile, the display information illustrated in FIG. 14B is display information generated by a map display application, and includes the character information and the image information, and the attribute is the image.

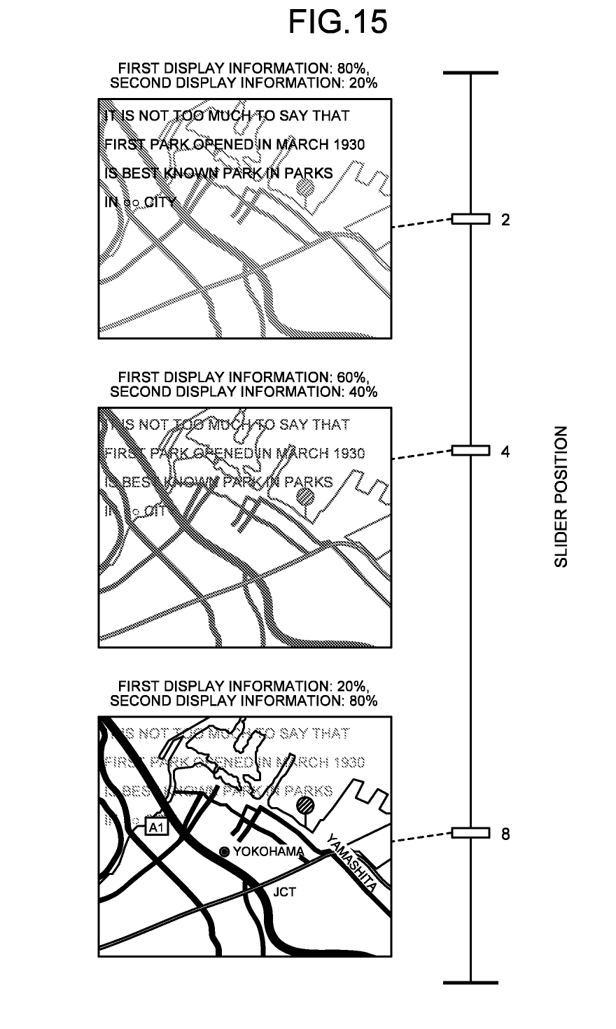

FIG. 15 is a diagram illustrating superimposed information in which the display information illustrated in FIG. 14A and the display information illustrated in FIG. 14B are superimposed as well as a slider position. As illustrated in FIG. 15, in a slider position 2, the first display information is displayed more clearly, and in the second display information, only the second image information of the second character information and the second image information is displayed. Accordingly, the first character information of the first display information and the second character information do not coexist. Further, in a slider position 4, while the second display information is displayed more clearly than that with the slider position 2, the second character information is not displayed. Therefore, the first character information and the second character information do not coexist, and the first character information can be displayed in a more easily viewable state. Further, in a slider position 8, the second character information is displayed more clearly than the first character information as the first display information. Accordingly, the second character information and the second image information of the second display information can be preferentially displayed to the first character information.

As described above, the information display device 1 can preferentially display one of the two pieces of display information even when superimposing and displaying the display information including the character information and the image information, and the display information including only the character information or the image information in the display unit 10.

Further, in this example, when the user selects the “first park” in the first display plane, for example, an object related to the “first park” may be marked and displayed in the second display plane (displayed with diagonal lines in FIG. 15). Accordingly, these two pieces of display information can be displayed in association with each other.

Further, as a second modification, when one of two pieces of display information to be displayed in the display unit 10 is written in a markup language such as the HyperText Markup Language (HTML), the information display device 1 may cause information to be displayed in the display unit 10 to be only the character information even if the display information includes the character information and the image information.

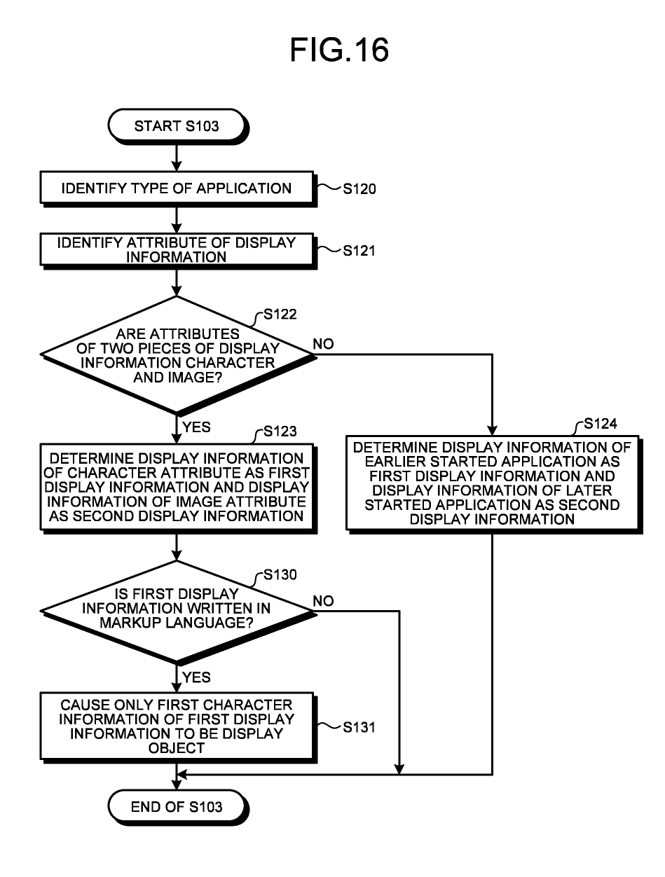

FIG. 16 is a flowchart illustrating detailed processing in the attribute determination processing (step S103) in this example. In the processing of FIG. 16, processing from steps S120 to S124 is similar to the processing described in FIG. 12. In step S123, after determining the first display information and the second display information, the attribute determination unit 103 determines whether the first display information is written in a markup language (step S130). When the first display information is written in a markup language (Yes in step S130), only the first character information of the first character information and the first image information included in the first display information is determined to be the object to be displayed that is to be displayed in the display unit 10 (step S131). In this case, the transmittance setting unit 105 multiplies the first image information by the transmission coefficient 0%, and changes the transmittance of the first image information to 100%. Accordingly, the first image information is not displayed in the display unit 10 regardless of the display ratio. Note that, in step S130, when the first display information is information not written in a markup language (No in step S130), the processing of step S131 is not performed, and the attribute determination processing (step S103) is terminated.

As described above, in the cross-fading of two pieces of display information in the present example, only the first character information cross-fades regarding the first display information written in a markup language. Note that, in this case, the first character information may be displayed in the display position in the original display information generated by the application. Further, as another example, the first character information may be displayed by applying only new line information in the original display information, such as left-justifying and displaying the information in a predetermined region. Accordingly, the visibility of the second display information can be improved.

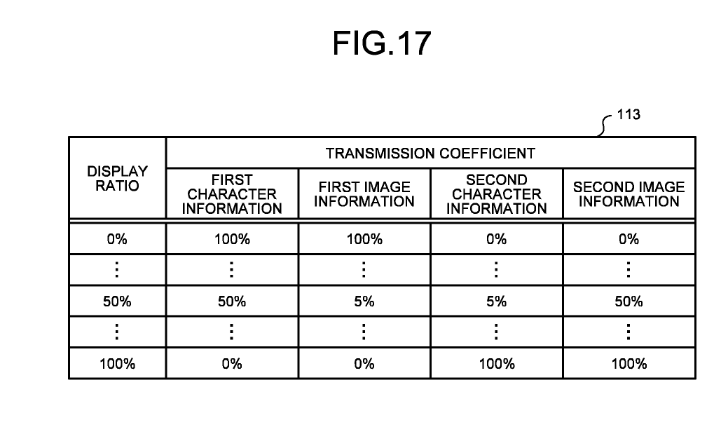

Further, as a third modification, while the information display device 1 according to the present embodiment includes the function identification table 112 in which the functions for determining each transmission coefficient of the first character information, the first image information, the second character information, and the second image information are stored, and determines the transmission coefficient to be multiplied to each piece of information based on each function and a predetermined display ratio, an information display device may include a transmission coefficient table 113 illustrated in FIG. 17, in place of the function identification table 112.

The transmission coefficient table 113 stores display ratios and respective transmission coefficients of first character information, first image information, second character information, and second image information in association with each other. Then, a transmittance setting unit identifies a transmission coefficient associated with a predetermined display ratio in the transmission coefficient table 113, and multiplies the corresponding information by the identified transmission coefficient, thereby to change the transmittance of each piece of information.

According to the information display device of the present embodiments, each piece of display information is displayed in an easily viewable state by the user.

Although the invention has been described with respect to specific embodiments for a complete and clear disclosure, the appended claims are not to be thus limited but are to be construed as embodying all modifications and alternative constructions that may occur to one skilled in the art that fairly fall within the basic teaching herein set forth.

What is claimed is:

1. An information display device comprising:
a transmittance setting unit configured
to set, to a first character transmittance, a character information transmittance that indicates a degree that character information included in first display information of display information to be displayed in a display unit transmits second display information that is the display information, and
to set, to a first image transmittance different from the first character transmittance, an image information transmittance that indicates a degree that image information included in the first display information transmits the second display information;
a superimposed information generation unit configured to generate superimposed information in which the second display information and the first display information to which the transmittances have been set by the transmittance setting unit are superimposed; and
a display processing unit configured to display the superimposed information in the display unit.

2. The information display device according to claim 1, wherein
the first character transmittance is a lower value than the first image transmittance,
the transmittance setting unit
sets a transmittance of the character information included in the second display information to a second character transmittance, and further
sets a transmittance of the image information included in the second display information to a second image transmittance that is lower than the second character transmittance, and
the superimposed information generation unit generates the superimposed information in which the first display information, which includes the character information and the image information to which the transmittances have been set by the transmittance setting unit, and the second display information, which includes the character information and the image information to which the transmittances have been set by the transmittance setting unit, are superimposed.

3. The information display device according to claim 2, further comprising:
a reception unit configured to receive designation of at least one of display ratios of the first display information and the second display information from a user, wherein
the first character transmittance, the first image transmittance, the second character transmittance, and the second image transmittance are values determined based on display ratios of the first display information and the second display information, and
the transmittance setting unit, based on the at least one display ratio received by the reception unit,
sets the character information transmittance of the first display information to the first character transmittance, and sets the image information transmittance of the first display information to the first image transmittance, and further
sets the character information transmittance of the second display information to the second character transmittance, and sets the image information transmittance of the second display information to the second image transmittance.

4. The information display device according to claim 3, further comprising:
a storage unit configured to store
a first character function for calculating the first character transmittance from the display ratio of the display information of at least one of the first display information and the second display information,
a first image function for calculating the first image transmittance from the display ratio,
a second character function for calculating the second character transmittance from the display ratio, and
a second image function for calculating the second image transmittance from the display ratio, wherein
the transmittance setting unit,
based on the at least one display ratio received by the reception unit, and the first character function and the first image function stored in the storage unit,
sets the character information transmittance of the first display information to the first character transmittance, and
sets the image information transmittance of the first display information to the first image transmittance and further,
based on the at least one display ratio received by the reception unit, and the second character function and the second image function stored in the storage unit
sets the character information transmittance of the second display information to the second character transmittance, and
sets the image information transmittance of the second display information to the second image transmittance.

5. The information display device according to claim 4, wherein
the first character function is a function in which the first character transmittance is increased as the display ratio of the second display information is increased, and
the first image function is a function in which the first image transmittance is increased as the display ratio of the second display information is increased.

6. The information display device according to claim 5, wherein
the first character function is a function in which the first character transmittance becomes 100% when the display ratio of the second display information is a predetermined first display ratio, and
the first image function
is a function in which a ratio of an increase in the first image transmittance, as the display ratio of the second display information is increased, is larger than a ratio of an increase in the first character transmittance in the first character function, and
is a function in which the first image transmittance becomes 100% when the display ratio of the second display information is a predetermined second display ratio that is smaller than the first display ratio.

7. The information display device according to claim 4, wherein
the second character function is a function in which the second character transmittance is increased as the display ratio of the second display information is decreased, and
the second image function is a function in which the second image transmittance is increased as the display ratio of the second display information is decreased.

8. The information display device according to claim 7, wherein
the second image function is a function in which the second image transmittance becomes 100% when the display ratio of the second display information is a predetermined third display ratio, and
the second character function
is a function in which a ratio of an increase in the second character transmittance, as the display ratio of the second display information is decreased, is larger than a ratio of an increase in the second image transmittance in the second image function, and
is a function in which the second character transmittance becomes 100% when the display ratio of the second display information is a predetermined fourth display ratio that is larger than the third display ratio.

9. The information display device according to claim 2, further comprising:
an attribute determination unit configured to determine whether the display information is information having the character information as main information, or information having the image information as main information, based on an attribute of an application that generates the display information to be displayed in the display unit, wherein
the transmittance setting unit
sets the character information transmittance of the display information determined as the information having the character information as main information to the first character transmittance, and sets the image information transmittance of the display information determined as the information having the character information as main information to the first image transmittance, and further
sets the character information transmittance of the display information determined as the information having the image information as main information to the second character transmittance, and sets the image information transmittance of the display information determined as the information having the image information as main information to the second image transmittance.

10. The information display device according to claim 2, wherein
the first image transmittance is set to 100%, and
the transmittance setting unit sets the image information transmittance of the first display information to 100%.

11. The information display device according to claim 1, wherein
the superimposed information generation unit generates the superimposed information in which the first display information is superimposed on the second display information.

12. The information display device according to claim 3, further comprising:
a storage unit configured to store
a first character coefficient for calculating the first character transmittance,
a first image coefficient for calculating the first image transmittance,
a second character coefficient for calculating the second character transmittance, and
a second image coefficient for calculating the second image transmittance, in association with the display ratio, wherein
the transmittance setting unit,
based on the first character coefficient and the first image coefficient stored in the storage unit in association with the at least one display ratio received by the reception unit,
sets the character information transmittance of the first display information to the first character transmittance, and
sets the image information transmittance of the first display information to the first image transmittance, and further
based on the second character coefficient and the second image coefficient stored in the storage unit in association with the at least one display ratio received by the reception unit
sets the character information transmittance of the second display information to the second character transmittance, and
sets the image information transmittance of the second display information to the second image transmittance.

13. A method of displaying information executed in an information display device, the method comprising:
transmittance setting that includes
setting, to a first character transmittance, a character information transmittance that indicates a degree that character information included in first display information of display information to be displayed in a display unit transmits second display information that is the display information, and
setting, to a first image transmittance different from the first character transmittance, an image information transmittance that indicates a degree that image information included in the first display information transmits the second display information;
superimposed information generating that includes generating superimposed information in which the second display information and the first display information to which the transmittances have been set in the transmittance setting are superimposed; and
display processing that includes displaying the superimposed information in the display unit.

14. A computer program product comprising a computer-usable medium having computer-readable program codes embodied in the medium for causing a computer to execute:
transmittance setting that includes
setting, to a first character transmittance, a character information transmittance that indicates a degree that character information included in first display information of display information to be displayed in a display unit transmits second display information that is the display information, and
setting, to a first image transmittance different from the first character transmittance, an image information transmittance that indicates a degree that image information included in the first display information transmits the second display information;
superimposed information generating that includes generating superimposed information in which the second display information and the first display information to which the transmittances have been set in the transmittance setting are superimposed; and
display processing that includes displaying the superimposed information in the display unit.
